(19) United States
(12) Patent Application Publication
(10) Pub. No.: US 2011/0000159 A1
(43) Pub. Date: Jan. 6, 2011

(54) HAIL-RESISTANT ROOFING MEMBRANE AND METHOD FOR MAKING SAME

(76) Inventors: Dan Ben-Daat, Sharon, MA (US); Michael DiPietro, Chelmsford, MA (US)

Correspondence Address: Scott R. Foster;Pandiscio & Pandiscio, P.C., 470 Totten Pond Road, Waltham, MA, 02451, US

(21) Appl. No.: 12/721,171

(22) Filed: Mar. 10, 2010

Related U.S. Application Data
(60) Provisional application No. 61/270,134, filed on Jul. 2, 2009.

(51) Int. Cl. E04D 13/00; B32B 37/16; E04D 5/10

(52) U.S. Cl. 52/309.9; 156/192; 156/324

(57) ABSTRACT

A hail-resistant roofing membrane includes a flexible waterproof polymeric layer of material, a flexible layer of non-woven fabric joined throughout the area of a first surface thereof to the polymeric layer, and a flexible layer of foam material joined throughout the area of a first surface thereof to a second surface of the layer of non-woven fabric, the layer of foam material being adapted for attachment to a roof surface throughout the area of a second surface of the layer of foam material. The roofing membrane is adapted for attachment to an existing roof structure.

A method for making the membrane includes binding the polymeric layer, the non-woven fabric layer, and the layer of foam material together with the fabric layer disposed between the polymeric layer and the foam material.

### CROSS-REFERENCE TO RELATED APPLICATION

This application claims the benefit of U.S. Provisional Patent Application No. 61/270,134, filed Jul. 2, 2009, in the names of Dan Ben-Daat and Michael DiPietro.

### BACKGROUND OF THE INVENTION

1. Field of the Invention

This invention relates to roofing materials, and is directed more particularly to a layered hail-resistant roofing membrane provided with a non-woven fabric layer to provide tensile strength and at least one layer of a foam material for dissipation of impact energy inflicted upon the membrane by hailstones, and the like.

2. Description of the Prior Art

It is generally known to provide roofs with some sort of protection against the impact of hailstones.

In US 2005/0126099, there is shown and described a hail damage-resistant roof assembly including a roof deck forming part of a building structure and an insulation layer loose-laid over the roof deck and separated therefrom by strips of polyurethane foam, or other membrane material. An impact absorber is laid over the insulation layer. A water-proof membrane is loose-laid on the impact absorber and is provided with a wrinkle to provide for expansion and to prevent rupture of the membrane. The roof assembly is built in place.

In U.S. Pat. No. 5,195,290—Hulett there is disclosed a roofing shingle which can be applied to existing roof structures and which is resistant to hail. The shingle is composed of layers including a foundation lamina having a woven polyester mat, an asphalt layer, and a layer of treated weather surface material. The shingles are nailed to a roof surface.

In U.S. Pat. No. 5,571,596—Johnson there is described a roofing shingle designed to prevent hail damage. The shingle includes a fiberglass mat sandwiched between an upper layer of Kevlar fabric for high impact resistance, and a bottom layer of E-glass fabric for bending resistance. Small stones are embedded in the upper surface of the upper layer. The shingle is adapted to be nailed onto an existing roof.

U.S. Pat. No. 6,113,142—Tolbert relates to a hail-resistant cover having thereon a multiplicity of shaped individual units adapted to spread glancing impacts of hailstones so as to prevent direct impacts of hailstones on the cover.

U.S. Pat. No. 6,228,785—Miller et al and U.S. Pat. No. 6,709,994 Miller et al present an asphalt roofing material in which a substrate is coated with asphalt and a surface layer of granules is embedded in the asphalt.

While the above improvements have led to increased protection for roof tops and other exposed surfaces subjected to batterings by hailstones, there remains a need for a hail-resistant roofing material with sufficient strength and resilience to absorb pummeling by hailstones, particularly roofing material sufficiently flexible and compact to be stored in rolls and simply unrolled at structural roof locations and applied to the structural roof.

### SUMMARY OF THE INVENTION

An object of the invention is, therefore, to provide a hail-resistant roofing membrane which is of sufficient tensile strength to withstand hailstone battering without rupturing or tearing, sufficiently resistant to “give” to absorb the impact of hailstones, and sufficiently flexible to be rolled for storage and transportation and unrolled and applied to a roof structure.

A further object of the invention is to provide a method for making a hail-resistant roofing membrane.

With the above and other objects in view, as with hereinafter appear, a feature of the present invention is the provision of a hail-resistant roofing membrane comprising a flexible waterproof polymeric layer of material, a flexible layer of non-woven fabric joined throughout the area of a first surface thereof to the waterproof polymeric layer, and a layer of flexible foam material joined throughout the area of a first surface thereof to a second surface of the non-woven fabric, the flexible layer of foam material being adapted for attachment to a roof surface throughout the area of a second surface of the layer of foam material.

In accordance with a further feature of the invention, at least a portion of the layer of flexible foam material is integral with said non-woven fabric layer to form a composite layer, the composite layer being adapted for attachment to a roof surface throughout the area of a second surface of the foam insulation layer.

In accordance with a still further feature of the invention, the hail-resistent roofing membrane is sufficiently flexible to be wound into rolls for storage and transportation and readily unrolled for application to the roof surface.

In accordance with still a further feature of the invention, there is provided a method for making a hail-resistant roofing membrane for attachment to an existing roof structure, the method comprising the steps of providing a sheet having a layer of non-woven fabric bound to a layer of flexible foam material over entire abutting surfaces thereof, attaching a sheet of polymeric material to a surface of the layer of non-woven fabric removed from the flexible foam material, whereby to provide a hail-resistant roofing membrane wherein the flexible foam material is adapted for attachment to the roof structure.

In accordance with a still further feature of the invention, there is provided a method for making a hail-resistant roofing membrane, the method comprising the steps of providing a first layer of a polymeric waterproof material, providing a second layer comprising a composite layer of at least one non-woven fabric layer joined throughout a surface area thereof to a flexible foam layer, and joining the first and second layers throughout abutting surfaces thereof.

The above and other features of the invention, including various novel details of construction and combinations of parts and method steps, will now be more particularly described with reference to the accompanying drawing and pointed out in the claims. It will be understood that the particular membranes and methods embodying the invention are shown by way of illustration only and not as limitations of the invention. The principles and features of this invention may be employed in various and numerous embodiments without departing from the scope of the invention.

### BRIEF DESCRIPTION OF THE DRAWING

Reference is made to the accompanying drawing in which is shown an illustrative embodiment of the invention, from which its novel features and advantages will be apparent.

In the drawing:

FIG. 1 is a cross-sectional view of a roofing membrane illustrative of an embodiment of the invention.

### DESCRIPTION OF PREFERRED EMBODIMENTS

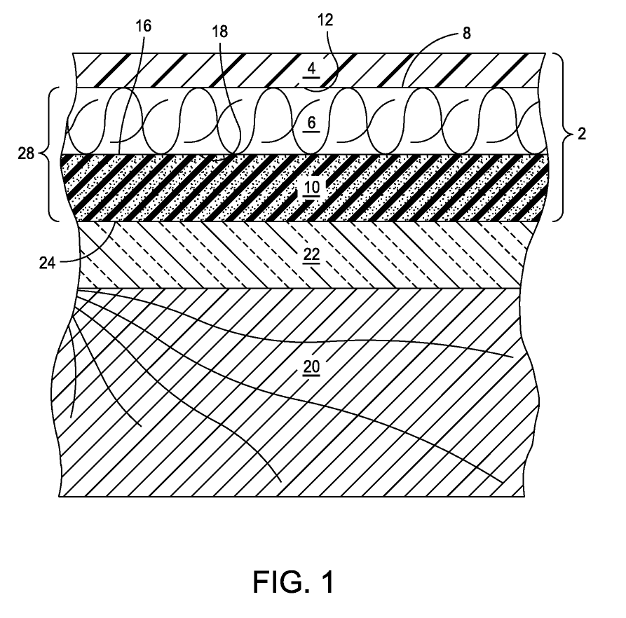

Referring to FIG. 1 it, will be seen that a hail-resistant roofing membrane 2 includes a first layer 4 of a flexible waterproof polymeric material and a second layer 6 of flexible non-woven fabric joined throughout the area of a first surface 8 thereof to the first layer 4. The membrane 2 further includes a third layer 10 of flexible foam material. The third layer 10 is joined throughout the area of a first surface 16 thereof to a second surface 18 of the non-woven fabric layer 6. The third layer 10 is adapted for attachment to a roof surface 20, or a layer 22 of insulative material fixed to the roof surface 20, throughout the area of a second surface 24 of the third layer 10.

The third layer 10 of foam material is a flexible foam, while the material of layer 22 constitutes a foam insulation of lesser flexibility, the layer 10 being adapted to absorb hailstone impact energy, while layer 22 is essentially an insulator.

Preferably, the first layer 4 is a single ply polymeric roofing membrane of a sort currently in use in roofing, and the second layer 6 is preferably a glass fiber mat. The flexible foam layer 10 may be either a closed cell foam or an open cell foam.

The non-woven fabric second layer 6 serves to provide tensile strength to the membrane 2, while the flexible foam material layer 10 serves to dissipate the impact energy inflicted upon the roofing membrane 2.

All of the layers 4, 6, 10 of the roofing membrane 2 are sufficiently flexible to permit the assembly of layers to be wound into rolls for storage and transportation and then unwound at a roofing site for application to a roof structure 20 or roof structure insulator 22.

In a preferred embodiment, the non-woven fiber layer 6 and the flexible foam layer 10 form a composite layer 28 (FIG. 1) and the roofing membrane 2 comprises the first layer 4 of polymeric waterproof material, the composite layer 28 having therein the non-woven fabric 6 and the flexible foam 10, adapted for attachment to the structural roof deck 20 or roof insulator 22.

In the preferred embodiment, the waterproof polymeric membrane 2 comprises the single ply roofing membrane 4, the layer of non-woven fabric 6 comprises glass fiber mat, and the flexible foam layer 10 comprises either one of closed cell foam or open cell foam.

The composite layer non-woven fabric 6 provides tensile strength to the roofing membrane 2 and the composite layer flexible foam 10 provides for dissipation of impact energy inflicted upon the roofing membrane.

The invention further includes a method for making a hail-resistant roof membrane for attachment to an existing roof structure.

The method for making the hail-resistant roofing membrane comprises the steps of providing a membrane 2 having a layer of non-woven fabric 6 bound to a layer of flexible foam material 10 over entire abutting surfaces 16, 18 thereof, and attaching a sheet of polymeric material 4 to a surface 8 of the first layer 6 removed from the flexible foam material 10, thereby to provide a hail-resistant roofing membrane 2 wherein the foam material 10 is adapted for attachment to the roof structure 20.

Alternatively, the method for making a hail-resistant roofing membrane includes the steps of providing a first layer of a polymeric waterproof material 4, providing a second layer 28 comprising a composite layer of at least one non-woven fabric layer 6 joined throughout a surface area 18 thereof to a flexible foam layer 10, the second layer 28 being adapted to be attached to a structural roof deck 20, or an insulative covering 22 thereon, and joining, the first and second layers 4, 28 throughout abutting surfaces 8, 12 thereof.

The method further includes the step of gathering the roof membrane into a roll adapted for un-rolling onto a roof surface in preparation for application to the roof surface.

The roofing membrane 2 comprises the single ply roofing membrane 4 of waterproof polymeric material, and the layer of non-woven fabric preferably comprises glass fiber mat. The polymeric layer of material comprises a single ply membrane having a thickness of 30-100 mil. The flexible layer of foam material 10 comprises a selected one of closed cell foam material and open cell foam material.

There is thus provided a roof membrane adapted for attachment to a roof structure and resistant to hail-inflicted damage, the membrane providing water-proof integrity, tensile strength, impact energy dissipation, and insulation, and being sufficiently flexible to be rolled into sizes convenient for storage, shipping, and utilization at a roofing work site.

It will be understood that many additional changes in the details, materials, method steps and arrangement of parts, which have been herein described and illustrated in order to explain the nature of the invention, may be made by those skilled in the art within the principles and scope of the invention as expressed in the appended claims.

What is claimed is:

1. A hail-resistant roofing membrane comprising:
a flexible waterproof polymeric layer of material;
a flexible layer of at least one non-woven fabric joined throughout the area of a first surface thereof to said waterproofing polymeric layer; and
a flexible layer of foam material joined throughout the area of a first surface thereof to a second surface of said non-woven fabric, said flexible layer of foam material being adapted for attachment to a roof surface throughout the area of a second surface of said layer of foam material.

2. The roofing membrane in accordance with claim 1, wherein
said layer of foam material comprises a flexible foam adapted to dissipate impact energy inflicted upon the membrane.

3. The roofing membrane in accordance with claim 1, wherein said waterproof polymeric layer of material comprises a single ply roofing membrane.

4. The roofing membrane in accordance with claim 1, wherein said layer of non-woven fabric comprises glass fiber mat.

5. The roofing membrane in accordance with claim 1, wherein said flexible layer of foam material comprises a selected one of closed cell foam material and open cell foam material.

6. The roofing membrane in accordance with claim 3, wherein said single ply roofing membrane is provided with a thickness of 30-100 mil.

7. The roofing membrane in accordance with claim 1, wherein:
said non-woven fabric layer provides tensile strength to the roofing membrane; and
said layer of foam material provides for dissipation of impact energy inflicted upon the roofing membrane.

8. The roofing membrane in accordance with claim 1, wherein said membrane is sufficiently flexible to be wound into rolls for storage and transportation and readily unrolled for application to the roof surface.

9. A hail-resistant roofing membrane comprising:
a first layer of a polymeric waterproof material;
a second layer comprising a composite layer of at least one non-woven fabric layer joined throughout a first surface area thereof to a flexible foam layer;
said second layer being adapted at a second surface area thereof to be attached to a structural roof deck.

10. The roofing membrane in accordance with claim 9, wherein said waterproof polymeric layer of material comprises a single ply roofing membrane.

11. The roofing material membrane in accordance with claim 9, wherein said layer of non-woven fabric comprises glass fiber mat.

12. The roofing membrane in accordance with claim 9, wherein said flexible foam layer comprises a selected one of closed cell foam material and open cell foam material.

13. The roofing membrane in accordance with claim 9, wherein in said composite layer:
said non-woven fabric provides tensile strength to the roofing membrane; and
said flexible foam provides for dissipation of impact energy inflicted upon the roofing membrane.

14. The roofing membrane in accordance with claim 9, where said membrane is sufficiently flexible to be wound into rolls for storage and transportation and readily unrolled for application to the roof surface.

15. A method for making a hail-resistant roofing membrane for attachment to an existing roof structure, the method comprising the steps of:
providing a sheet having a first layer of non-woven fabric bound to a second layer of flexible foam material over entire abutting surfaces thereof; and
attaching a sheet of polymeric material to a surface of the first layer removed from said flexible foam material;
whereby to provide a hail-resistant roofing membrane wherein the foam insulation material is adapted for attachment to the roof structure.

16. The method in accordance with claim 15, wherein the waterproof polymeric layer of material comprises a single ply roofing membrane.

17. The method in accordance with claim 15, wherein the flexible layer of foam material comprises a selected one of closed cell foam material and open cell foam material.

18. The method in accordance with claim 15, wherein the layer of non-woven fabric comprises glass fiber mat.

19. The method in accordance with claim 15, wherein the polymeric layer of material comprises a single ply roofing membrane having a thickness of 3-100 mil.

20. The method in accordance with claim 15 and further comprising the step of gathering the roof membrane into a roll adapted for un-rolling onto a roof surface in preparation for application to the roof surface.

21. A method for making a hail resistant roofing membrane, the method comprising the steps of:
providing a first layer of a polymeric waterproof material;
providing a second layer comprising a composite layer of at least one non-woven fabric layer joined throughout a surface area thereof to a flexible foam layer; and
joining the first and second layers throughout abutting surfaces thereof.

22. The method in accordance with claim 21, wherein the waterproof polymeric layer of material comprises a single ply roofing membrane.

23. The method in accordance to claim 21, wherein the layer of non-woven fabric comprises glass fiber mat.

24. The method in accordance with claim 21, wherein the flexible foam layer comprises a selected one of closed cell foam material and open cell foam material.
